(19) United States
(12) Patent Application Publication
(10) Pub. No.: US 2024/0003019 A1
(43) Pub. Date: Jan. 4, 2024

(54) METHOD AND SYSTEM FOR RECYCLING LITHIUM ION BATTERIES USING ELECTROCHEMICAL LITHIUM ION PURIFICATION

(71) Applicant: University of Kentucky Research Foundation, Lexington, KY (US)

(72) Inventors: Xin Gao, Lexington, KY (US); Ayokunle Omosebi, Lexington, KY (US); Aron Patrick, Louisville, KY (US); Kunlei Liu, Lexington, KY (US)

(21) Appl. No.: 18/213,054

(22) Filed: Jun. 22, 2023

Related U.S. Application Data
(60) Provisional application No. 63/354,513, filed on Jun. 22, 2022.

(51) Int. Cl. C25B 1/16; C25B 1/02; C25B 9/15; C25B 9/19; C25B 11/042; H01M 10/54; C22B 1/02; C22B 7/00

(52) U.S. Cl. CPC C25B 1/16; C25B 1/02; C25B 9/15; C25B 9/19; C25B 11/042; H01M 10/54; C22B 1/02; C22B 7/007

(57) ABSTRACT

A method of recycling lithium-ion batteries includes steps of: roasting black mass from lithium-ion batteries to produce a reduced black mass, conducting simultaneous aqueous leaching and wet magnetic separation of the reduced black mass for (a) extracting soluble lithium species and (b) enriching metallic Ni—Co and subjecting the extracted soluble lithium species to electrochemical lithium ion purification. A system for recycling lithium ion batteries includes a roaster, an aqueous leaching and wet magnetic separator and an electrochemical lithium ion separator.

### RELATED APPLICATIONS

This application claims priority to U.S. Provisional Patent Application Ser. No. 63/354,513, filed on Jun. 22, 2022, the full disclosure of which is hereby incorporated by reference.

### TECHNICAL FIELD

This document relates generally to battery recycling and, more particularly, to new and improved methods and apparatus for recycling lithium ion batteries using electrochemical lithium ion purification.

### BACKGROUND

By 2040, 58% of all cars sold worldwide are anticipated to be electric vehicles (EVs). With increases in EVs and the sizes of their batteries, significant numbers of end-of-life (EoL) lithium-ion batteries (LIBs) are and will be produced each year, which, if not properly recycled, will make significant environmental impacts, and accelerate the depletion of mineral reserves. The International Energy Agency estimates that EVs produced in 2019 alone generated 500,000 tons of LIB waste, and the total amount of waste generated by 2040 may be as much as 8,000,000 tons. Increases in the LIB wastes will only increase in the coming decades, as approximately 90% of the global grid energy storage from renewable resources and various electronic devices are using LIBs these days. Therefore, enriching or recovering high-value metals of Ni, Co, and Li from the EoL LIB wastes has been gaining the interest to the EV manufacturers, battery producers, and material suppliers.

Enriching high-value metals from the LIB waste is a multistep process. The process begins commonly with making black mass, mixed solid particles coming from shredding or crushing the drained LIBs accompanied by mechanical and/or manual separation. Therefore, the black mass may contain all the parts of a LIB, including active materials from the cathode, graphite from the anode, Al and Cu from the current collectors, battery electrolyte, plastic separator, plastic and/or iron casings, etc. The high-value species like Co, Ni, and Li come from active materials like lithium cobalt oxide (LCO), lithium manganese nickel cobalt oxide (MNC), lithium nickel cobalt aluminum oxide (NCA), lithium iron phosphate (LPO), etc. Under such a scenario, to enrich these high-value metals, thermal and/or chemical treating black mass become the essential steps together with the additional separation and purification.

The atmosphere-assisted roasting of the black mass is one of the thermal-chemical processes to decompose the active materials under the reducing atmosphere toward forming H₂O soluble Li salts and metal oxides or metallic metal. Reducing LCO with sufficient graphite likely yields Li₂CO₃ and Co via 4LiCoO₂(s)+C(s)→2Li₂O(s)+4CoO(s)+CO₂(g), Li₂O(s)+CO₂(g)→Li₂CO₃(s), and 2CoO(s)+C(s)→2Co(s)+CO₂(g). Herein, recovering Li₂CO₃ from the Co mixed with graphite is achieved by H₂O leaching followed by evaporation, while separating Co from graphite can be performed via either magnetic separation or acid leaching. As shown in Table 1, such a combined process has enriched Li, Co, Ni, and Mn from various types of black mass primarily containing one active material and one solid reducing agent, which features the simplicity-operated process, matured process techniques, minimized chemical uses, fair metal recovery rates, but a high heating requirement for roasting black mass.

TABLE 1
Summary of using atmosphere-assisted roasting followed by
water leaching for Li recovery and wet magnetic separation
or acid leaching for Co, Ni, and Mn recoveries. Please
note that atmosphere- assisted roasting means that the
reduction of active materials occurs only via carbothermic,
thermite, and reducing gas-assisted reactions.

| Black Mass and | | Metal Product | |
|---|---|---|---|
| Testing Condition | | Li Product | Metal Product |
| Black Mass | Reducing | Recovery Rate | Recovery Rate |
| Constituent | Condition | Method | Method |
| NCA, | Graphite, H2 | LiOH or | Ni—Co |
| graphite, | 400-900° C. | Li2CO3 | 88% |
| electrolyte, | | 80% H2O | Mag. Sep. |
| Cu, and Al | | leaching, | |
| | | ELIS | |
| LCO, binder, | Graphite, H2 | LiOH | Metallic Co |
| carbon, and | 500-1000° C. | 43% | 88% |
| graphite | | H2O leaching | Mag. Sep. |
| MNC and | Graphite | Li2CO3 | Ni—Co—NH4⁺ |
| graphite | 450-850° C. | 82% | liq. >98% |
| | | H2O leaching | Ammonia leaching |
| LCO and Al | Al | Li3PO4 | CoSO4 treatment |
| | 550-750° C. | 92% | ^{[8]}Chem. |
| | | Chem. treatment | |
| LCO and | Graphite | Li2CO3 | Metallic Co |
| graphite | (500-900° C.) | H2O leaching | 90% |
| | | | Mag. Sep. |
| LMO and | Graphite | Li2CO3MnO | |
| graphite | (400-900° C.) | 82% H2O | |
| | | leaching | |
| MNC and | Lignite | Li2CO3 | Co—, Ni—, MnSO4 |
| lignite | (650° C.) | 85% | 99% |
| | | H2O leaching | Acid leaching |
| LCO and | Graphite | Li2CO3 | Metallic Co |
| graphite | (850-1000° C.) | 99% | 96% |
| | | H2O leaching | Mag. Sep. |
| LCO and | Graphite | Li2CO3 | Metallic Co |
| graphite | (850-1000° C.) | H2O leaching | 97% |
| | | | Mag. Sep. |

The new and improved method and apparatus further process the extracted soluble lithium species in the H₂O leachate producing purified LiOH or Li₂CO₃, a typical precursor for producing the cathode active material at an industrial scale. The is accomplished by means of electrochemical purification in an electrochemical Li-ion separator (ELIS), a flow electrolyzer that is described in greater detail below.

### SUMMARY

In accordance with the purposes and benefits described herein, a new and improved method of recycling lithium-ion batteries, comprises, consists of or consists essentially of: (a) roasting black mass from the lithium-ion batteries to produce a reduced black mass, (b) conducting simultaneous aqueous leaching and wet magnetic separation of the reduced black mass for extracting soluble lithium species and enriching metallic Ni—Co, and (c) subjecting the extracted soluble lithium species to electrochemical lithium ion purification.

In at least one of the many possible embodiments, the method further includes producing hydrogen gas during the electrochemical lithium ion purification. Still further, the method may include using the hydrogen gas produced during the electrochemical lithium ion purification to perform the roasting of the black mass. Adding 2-4 Vol % of H₂ balanced with a type of inert gas (e.g., N₂ or Ar) can reduce the heating requirement during the roasting in comparison of the case when solely using an inert gas.

In at least some embodiments, the subjecting of the extracted soluble lithium species to electrochemical lithium ion purification includes (a) generating hydroxide ions and hydrogen gas at a cathode in a cathode compartment of a flow cell on a first side of an ion exchange membrane, (b) generating oxygen gas at an anode in an anode compartment of the flow cell, (c) allowing passage of lithium ions from the extracted soluble lithium species through the ion exchange membrane from the anode compartment to the cathode compartment to balance out the hydroxide ions generated at the cathode and (d) recovering purified lithium hydroxide from the flow cell. Still further, the method may include using the hydrogen gas produced during the electrochemical lithium ion purification to perform the roasting of the black mass.

Still further, the method may include applying a voltage of about 2.5-6.5 volts at a current density of about 20-1150 mA/cm² across the anode and the cathode during the electrochemical lithium ion purification. In alternative embodiments, the method may also include contacting lithium hydroxide from the flow cell with carbon dioxide in a membrane contactor to produce lithium carbonate.

In at least some of the many possible embodiments, the method includes shredding or crushing lithium ion batteries to prepare the black mass for roasting.

In accordance with an additional aspect, a new and improved system is provided for recycling lithium ion batteries. That system comprises, consists of or consists essentially of: (a) a roaster adapted for reductive roasting of a lithium ion battery black mass and producing a reduced black mass, (b) an aqueous leaching and wet magnetic separator, downstream from the roaster, adapted for extracting soluble lithium species and enriching metallic Ni—Co from the reduced black mass, and (c) an electrochemical lithium ion separator (ELIS), downstream from the aqueous leaching and wet magnetic separator, adapted for purifying lithium hydroxide from the extracted lithium species.

In accordance with yet another aspect, a new and improved method of recycling lithium-ion batteries, comprises, consists of or consists essentially of: (a) shredding lithium ion batteries to produce a black mass, (b) roasting the black mass to produce a reduced black mass, (c) conducting simultaneous aqueous leaching and wet magnetic separation of the reduced black mass for extracting soluble lithium species and enriching metallic Ni—Co, and (d) subjecting the extracted soluble lithium species to electrochemical lithium ion purification. The method further includes conducting the shredding and the roasting (steps (a) and (b) above) at the site of the lithium ion battery supply and then transporting the reduced black mass to a remote location for the simultaneous aqueous leaching and wet magnetic separation and the lithium ion purification (steps (c) and (d) above).

In accordance with yet another aspect, a new and improved system is provided for recycling lithium ion batteries. That system comprises, consists of or consists essentially of: (a) a shredder adapted for shredding lithium ion batteries to produce a black mass, (b) a roaster adapted for reductive roasting of the black mass and producing a reduced black mass, (c) an aqueous leaching and wet magnetic separator, downstream from the roaster, adapted for extracting soluble lithium species and enriching metallic Ni—Co from the reduced black mass, and (d) an electrochemical lithium ion separator, downstream from the aqueous leaching and wet magnetic separator, adapted for purifying lithium hydroxide from the extracted lithium species.

In at least one possible embodiment, the shredder is in the form of a shredder module including (a) an upper or feed hopper for lithium ion batteries, (b) a shredder for shredding the lithium ion batteries received from the upper or feed hopper and (c) a lower or discharge hopper for receiving the black mass from the shredder and discharging the black mass to the roaster.

In at least some embodiments of the system, the shredder/shredder module and the roaster are mounted to one or more transportation vehicles so that they may be taken to the site of the lithium ion battery supply to shred and roast those lithium ion batteries to convert them to a reduced black mass before transporting off-site to a remote location for further processing.

In the following description, there are shown and described several preferred embodiments of the method and system for recycling lithium ion batteries. As it should be realized, that method and system are capable of other, different embodiments and their several details are capable of modification in various, obvious aspects all without departing from the method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate certain aspects of the method and together with the description serve to explain certain principles thereof.

FIG. 1 is a schematic block diagram of one possible embodiment of a system and method for recycling lithium ion batteries using electrochemical lithium ion purification.

FIG. 1A is a schematic illustration of the details of the electrochemical lithium ion separator (ELIS) of the system illustrated in FIG. 1.

FIG. 2 is a schematic block diagram of an alternative embodiment of a system and method for recycling lithium ion batteries using electrochemical lithium ion purification.

FIG. 3A is an X-ray powder diffraction (XRD) pattern of a pristine black mass suggesting that lithium nickel cobalt aluminum oxide (NCA), graphite and copper (Cu) solids coexist in the black mass.

FIG. 3B is a face-scanned energy-dispersive X-ray spectroscopic (EDS) spectrum that shows the additional phosphorus (P), fluorine (F), iron (Fe) and silicon (Si) in the black mass.

FIG. 4 illustrates XRD patterns for respective (a) pristine black mass, (b) reduced black mass and (c) lithium (Li) extracted black mass as per Steps 1 and 2 of FIG. 1 with the right and left side plots showing the phase changes regarding the metallic Ni—Co and Li salts, respectively, during the carbothermic reactions and then H₂O leaching.

FIG. 5 is a face-scanned EDS spectrum of the solids after removing H₂O from the H₂O leachate. In addition to Li^{t}, CO₃²⁻, and F⁻ identified by the XRD patterns in FIG. 4(a)-(c), Al and Si are observed.

FIG. 6 is a face-scanned EDS spectrum of the dried solids after removing H₂O from the processed catholyte, showing no detection of F, Al, Si and P.

FIGS. 7A-7C are respective XRD patterns of (A) the standard Li₂CO₃, (B) solids from drying the catholyte, and (C) solids from drying the CO₂ treated catholyte.

FIGS. 8A-8D are respective EDS spectra of the dried solids coming from (A) the starting anolyte (H₂O leachate), (B) the strating catholyte (prepared LiOH), (C) ending anolyte and (D) ending catholyte.

FIG. 9 is XRD patterns of the solids from drying the ending catholyte under vacuum.

Reference will now be made in detail to the present preferred embodiments of the method.

### DETAILED DESCRIPTION

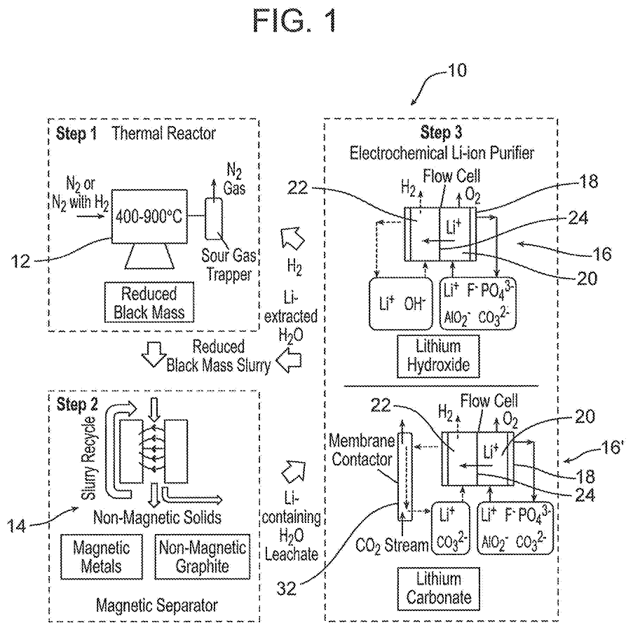

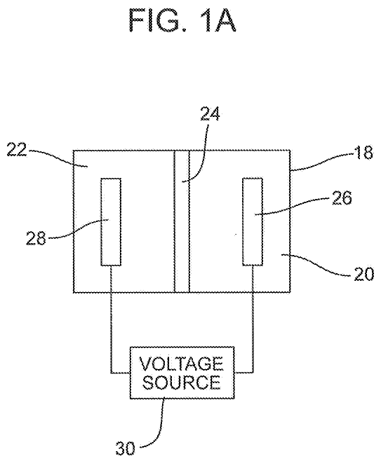

As set forth in FIG. 1, the new and improved system 10 for recycling lithium ion batteries includes a roaster 12, an aqueous leaching and wet magnetic separator 14, downstream from the roaster, and an electrochemical lithium ion separator 16 downstream from the aqueous leaching and wet magnetic separator.

The roaster 12 is adapted for reductive roasting of a lithium ion battery black mass to produce a reduced black mass. For purposes of this document, “black mass” refers to shredded or crushed whole lithium ion batteries, including active materials from the cathode, graphite from the anode, Al and Cu from the current collectors, battery electrolyte, plastic separator, plastic and iron casings, etc. The high-value species like Co, Ni, and Li come from active materials like lithium cobalt oxide (LCO), lithium manganese nickel cobalt oxide (MNC), lithium nickel cobalt aluminum oxide (NCA), lithium iron phosphate (LPO), etc. Under such a scenario, to enrich these high-value metals, thermal and/or chemical treating black mass become the essential steps together with the additional separation and purification.

The atmosphere-assisted roasting of the black mass is one of the thermal-chemical processes to decompose the active materials under the reducing atmosphere toward forming H₂O soluble Li salts and metal oxides or metallic metal.

The aqueous leaching and wet magnetic separator 14 is adapted for (a) extracting soluble lithium species and (b) enriching metallic Ni—Co from the reduced black mass received from the roaster 12. Eriez® wet drum separators may be used for this purpose. One of the key results from phase and speciation analysis shows that approximately 90% of Ni—Co solids can be recovered with the purity of about 90%; however, the dissolved anions like AlO₂—, F—, PO₄³⁻, and Si₄O₈(OH)₄₄— in the H₂O leachate significantly impact the quality of Li₂CO₃ even though around 80% Li recovery can be achieved.

The electrochemical lithium ion separator (ELIS) 16 is adapted for purifying lithium hydroxide or lithium carbonate from the extracted lithium species received from the aqueous leaching and wet magnetic separator 14. Lithium hydroxide and lithium carbonate are typical precursors for producing cathode active material at an industrial scale. As shown in FIGS. 1 and 1A, the electrochemical lithium ion separator 16 includes a flow cell or electrolyzer 18 having an anode compartment 20, a cathode compartment 22 and a cation exchange membrane 24 separating the anode compartment and the cathode compartment. The cation exchange membrane 24 may be made of polymeric materials containing fixed negatively charged species, e.g., sulfonic groups, which allows only positively charged species to pass through. Nafion, Fumasep, and Aquivion are the common brands for cation exchange membranes 24 that may be used in the electrochemical lithium ion separator 16.

An anode 26 is provided in the anode compartment 20 and a cathode 28 is provided in the cathode compartment 22. The anode 26 may be a dimensionally stable anode and may be made from any appropriate non-corrosive material including, but not necessarily limited to titanium. The cathode 28 may be made from any appropriate material including, but not necessarily limited to, graphite, iron, nickel, iron-nickel alloy, nickel-chromium alloy or combinations thereof. The system 10 also includes a voltage source 30 adapted to supply a voltage potential across the anode 26 and the cathode 28. Further, the voltage source 30 may be adapted to supply a voltage of about 2.5-6.5 volts at a current density of about 20-1150 mA/cm² across the anode 26 and the cathode 28 during the electrochemical lithium ion purification.

Due to the use of the cation-selective membrane 24, only Li⁺ in the anolyte loop (solid action arrows) can pass through the membrane under the electrical field to balance the OH⁻ in the catholyte loop (dashed action arrows). Therefore, the electrochemical lithium ion separator 16 produces a purified LiOH salt. In addition, the co-produced hydrogen gas (H₂) can be used to fuel the roaster 12 and lower the fuel or energy requirement of the upstream roasting process.

In an alternative embodiment of the system 10, the electrochemical lithium ion separator 16′ further includes a membrane contactor 32, of a type known in the art, that is adapted for contacting the purified lithium hydroxide received from the flow cell 18 with carbon dioxide and converting the purified lithium hydroxide to lithium carbonate. Such a membrane contactor 32 includes a shell side and a lumen side. Liquid containing Li ions can be fed into either the shell or lumen side. For example, if liquid enters into the lumen side, a CO₂ stream will be fed into the shell side.

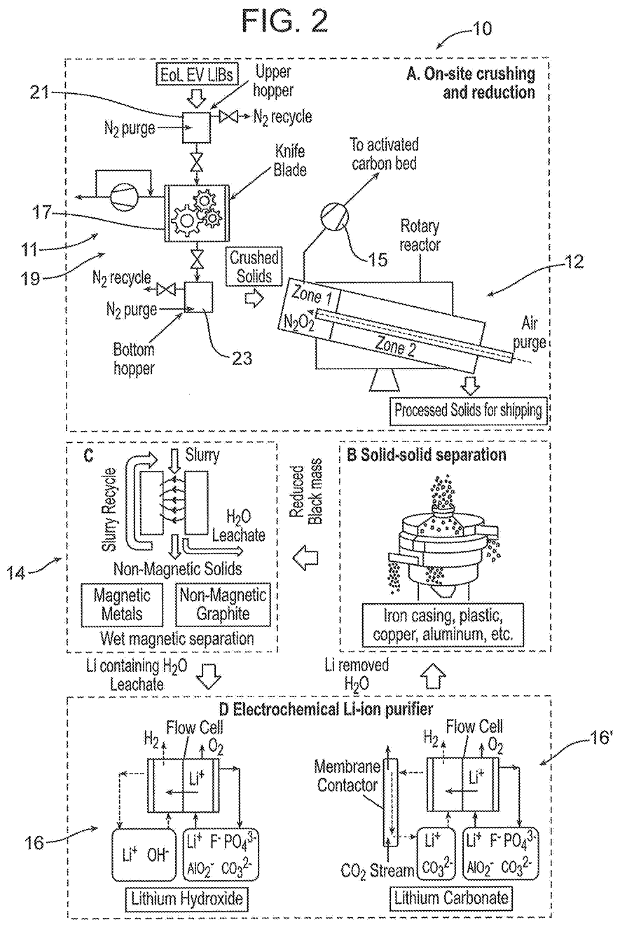

FIG. 2 depicts an alternative embodiment of the system 10 which happens to take the form of a pilot-scale design for the pyrometallurgic process paired with ELIS to enrich the valuable materials like metallic Ni—Co alloy, graphite, LiOH and/or Li₂CO₃ from the end-of-life (EoL) lithium-ion batteries (LIBs) of electric vehicles (EVs). The system 10 includes a shredder 11 upstream from the roaster 12. That shredder 11 is adapted to shred or crush the lithium ion batteries before they are fed to the roaster 12. Any shredding or crushing of the lithium batteries is done under an inert gas, such as nitrogen (N₂) or under vacuum. As shown in FIG. 2, the system 10 may actually include a crusher module 19, including an upper hopper 21, the crusher 17 and a lower hopper 23. The upper hopper 21 is used to feed whole lithium ion batteries to the shredder 11. The lower hopper 23 receives the black mass from the shredder 11 for subsequent feeding to the roaster 12.

The roaster 12 in FIG. 2 is a rotary reactor including an activated carbon bed 15 adapted for capturing volatile organic compounds (VOCs) from the remains after thermal oxidizing plastic separators, plastic casing, binders (polyvinylidene fluoride or polyvinylidene difluoride), and/or organic gel from battery additives containing fluoride. Approximately 20 vol % of oxygen (O₂) will be consumed with plastics, binders, and carbon black in zone 1 of the rotary reactor 12, thus providing an inert environment for reducing the battery active materials. In one possible embodiment, the rotary reactor 12 is 1.525-6.1 meters long, has an inner diameter of 10-20.5 centimeters, an inclined angle of 5-15 degrees, and a rotating speed of about 5-60 rpm.

In some particularly useful embodiments, the shredder 11 and the roaster 12 are mounted on vehiclesV (e.g. truck beds or tractor trailers) to allow them the necessary mobility to be taken to the site or source of the lithium battery supply (battery collection sites). The on-site crushing/shredding and reduction mitigates any thermal runaway that may occur during transporting the end of life lithium ion batteries and lift transportation limits of the hazardous materials from the lithium ion batteries. For example, in Box A of FIG. 2, sorted end of life lithium ion batteries will be fed without any pre-treatment into the upper hopper 21 with nitrogen (N₂) as protection gas, and then shredded into the solids as large as 0.3-0.5 in t in a knife blade grinder 17 under vacuum and inert atmosphere. The crushed solids (including plastics, casing, black mass, etc.) will be gradually delivered to a rotary reactor 12 from the bottom hopper 23, the same configuration as the upper hopper. In the heating chamber of the rotary reactor 12, air will be continuously fed to Zone 1 at 400-500° C., in which plastics, binder, and unoxidized lithium (from the anode) are preferably combusted with oxygen (O₂) from air due to their reactivities, concurrently burning out the VOC to minimize the formation of polychlorinated dibenzofurans (PCDFs) in the presence of Cu as catalyst and supplying a part of the heat toward the following carbothermic reactions under the oxygen-free atmosphere. In Zone 2, only the cathode active materials from the black mass (containing the cathode active materials, graphite, and trace of additional solids) are thermally reduced at 500-700° C. by graphite and/or carbon black in the battery, resulting in the metallic solids and Li salts mixed with unreacted graphite, Cu, Al and casing Fe. Once the on-site reduction is completed, all the solids will be packed and shipped to a centralized refinery for further processing by electrochemical lithium ion purification.

Centralized Metal and Graphite Recovery Process—Since the metallic solids such Ni and Co from the lithium ion batteries are typically magnetic at size less than 15 μm, and LiOH and Li₂CO₃ (for this technology) are H₂O soluble, wet sifting and magnetic separation in Boxes B and C are the option to separate the active materials and magnetic alloy and non-magnetic graphite, remaining Fe, Cu, and Al from Li-containing H₂O leachate. For instance, the wet sifting along with vibration will be used to remove the large solids like Fe, Cu and Al based upon the size exclusion working principle in Box B. Subsequently, the magnetic alloy, e.g., Ni—Co when using NCA-based black mass, Ni—Co—MnO when using MNC-based black mass, Co when using LCO-based black mass, and/or Fe when using LPF-based black mass, is recovered from a wet magnetic separator in Box C. To upgrade either LiOH or Li₂CO₃ by filtering the additional anions like AlO₂⁻, F⁻, PO₄³⁻, and Si₄O₈(OH)₄⁴⁻, Li-containing H₂O leachate is fed into an electrochemical Li-ion separator (ELIS) 16, in which only Li cations pass through the cation-exchange membrane 24 to produce either LiOH or Li₂CO₃ liquor with CO₂ resources without foreign chemicals added. Herein, the co-generated H₂ gas from the ELIP 16 can be a saleable commodity. The Li-removed H₂O will be recycled to extract H₂O soluble Li salts from the reduced solids in Box B.

Summarizing, the system 10 and method disclosed herein are characterized by a number of significant advantages over prior art approached for lithium ion battery recycling. These include, but are not necessarily limited to:
1) Process intensification and simplicity: using one device (or one step) to offer LiOH or Li₂CO₃ production with no needs of chemicals, pressure, or heating.
2) H₂ utilization: creating an eco-friendly pathway to reduce the heating requirement of roasting process while mitigating carbon emission.
3) H₂O conservation: reusing Li-extracted H₂O leachate to prepare the reduced black mass slurry.

### Experimental

### B1. Pilot-Scale Process Design

### C. Data Provided to Support Readiness of Invention

### C1. Pristine Black Mass

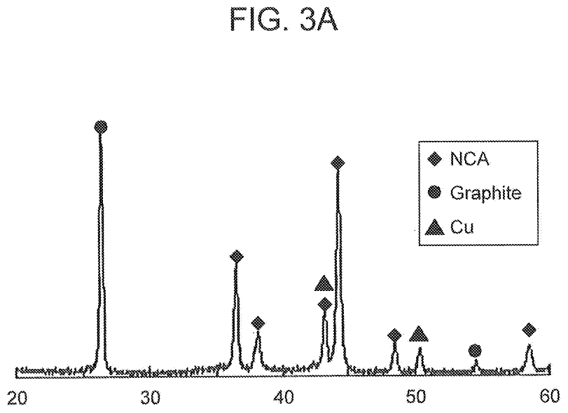

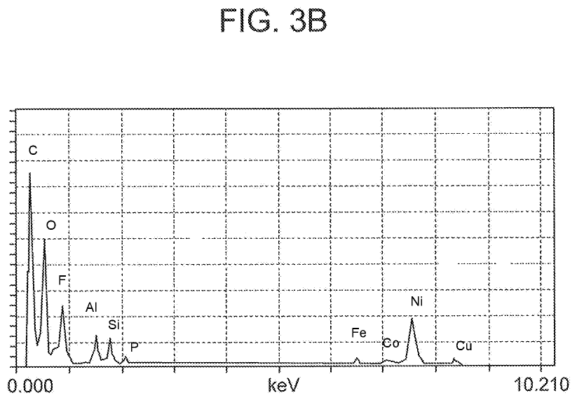

Peak assignments of the X-ray powder diffraction (XRD) pattern in FIG. 3(a) suggest that the pristine black mass consists of NCA, graphite, and Cu solids, for the case study being reported. Other black mass may contain a similar or different composition, but the method can be directly applied. Additional F, P, Fe, and Si are observed in the energy-dispersive X-ray spectroscopic (EDS) spectrum of FIG. 3(b) when the same black mass was tested. Herein, the F and P come from the battery electrolyte, LiPF₆, the Fe stems from the battery casing, and the Si may be either an additive for the anode chemistry or a contaminant from the crushing. Based on the inductively coupled plasma—atomic emission spectroscopic (ICP-AES) analysis, the mole ratio of graphite to NCA is estimated to be 5 to 8 in the black mass. Therefore, the graphite is sufficient to drive the carbothermic reactions for reducing the NCA under an inert atmosphere like N₂ or Ar at an elevated temperature. In case graphite is insufficient to proceed the carbothermic reactions, 4 vol % H₂ can be mixed with inert gas to enhance the reduction of active materials.

### C2. Preparing Lithium Containing H2O Leachate

### C2.1. Preparing Reduced Black Mass Using Carbothermic Roasting

12.089 g of the pristine black mass on a quartz boat was roasted using a Carbolite Gero tube furnace under the N₂ atmosphere at 1 L min⁻¹. The roasting process started from room temperature to 700° C. at the ramping rate of 20° C. min⁻¹, followed by an isothermal step for 2 hours. Once the process was completed, the black mass, named reduced black mass in the following text, was characterized using XRD to validate the effectiveness of carbothermic reductions for producing the Li salts and magnetic Ni—Co.

### C2.2. Li Extraction Process

8.458 g of the reduced black mass was placed into deionized water at the liquid to solid weight ratio of 50 in a high-density polyethylene (HDPE) bottle. Sonication was performed using a typical water bath sonicator for 5 min to enhance the Li extraction. Solid-liquid separation was conducted using a typical vacuum-assisted separator. The resulting Li-containing liquid with additional species, named H₂O leachate in the following text, was stored in a HDPE bottle before further uses. 351.100 g of H₂O leachate was recovered after the solid-liquid separation, and characterized in terms of pH, conductivity, and alkalinity. Approximately 50 g of H₂O leachate (without any treatment) was directly dried in a Thermo Scientific oven at 105° C. for about 24 hours to recover Li salts for element analysis by EDS. Finally, the solids collected from the solid-liquid separation (not from drying the H₂O leachate), named Li extracted black mass in the following text, were dried in a Thermo Scientific oven at 105° C. for evidencing the Li removal by XRD.

### C2.3. Identifying Dissolved Species in H2O Leachate

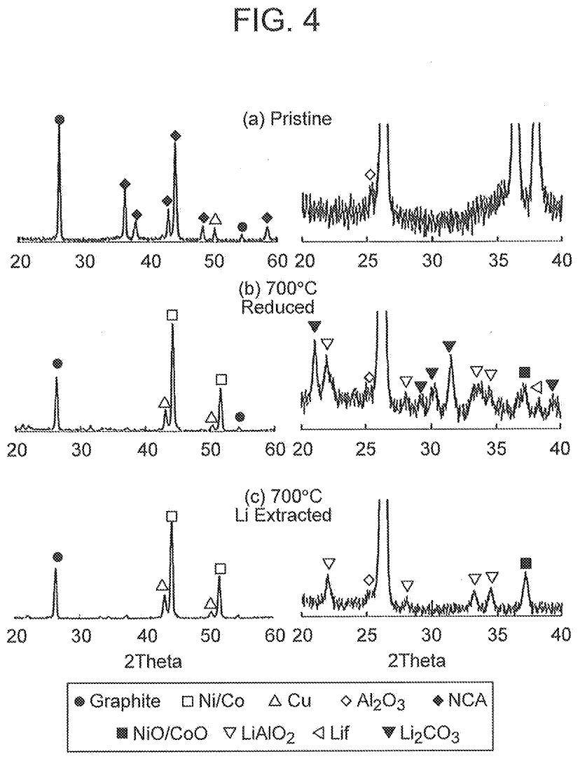

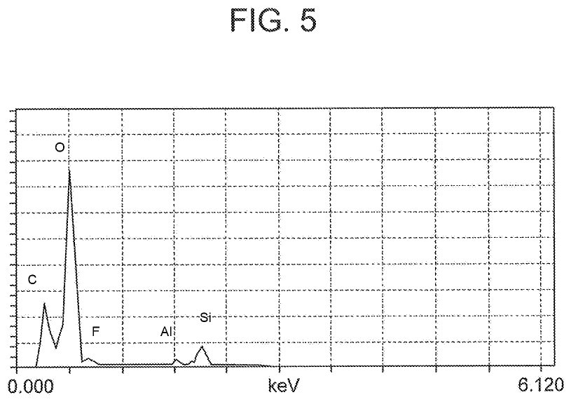

As depicted in the XRD patterns of FIG. 3 for (a) pristine versus (b) reduced black mass, the NCA in the pristine black mass is reduced at 700° C. under N₂ via carbothermic reactions, LiNi_{0.8}Co_{0.15}Al_{0.05}O₂+0.95C→0.475Li₂CO₃+0.15Co+0.8Ni+0.05LiAlO₂+0.475CO₂ resulting in Ni—Co, NiO—CoO, Li₂CO₃, LiAlO₂, and LiF in addition to the unreacted Cu and graphite. After placing the reduced black mass into deionized (DI) H₂O, Li₂CO₃ and LiF are dissolved toward forming Li^{t}, CO₃²⁻, and F⁻, as the peaks corresponding to these two Li salts vanish when looking at the XRD patterns of FIG. 4 for (b) reduced versus (c) Li extracted black mass. To identify the additional dissolved species in the H₂O leachate, the solids after removing H₂O were characterized using EDS. The elemental analysis in FIG. 5 shows the existence of Al, Si, and Pin the H₂O leachate. Since pH of the H₂O leachate was measured at 11.5-12.8, the Al, Si, and P should be in the form of AlO₂⁻, Si₄O₈(OH)₄₄⁻, and PO₄³⁻. In conclusion, to the best of our knowledge, the H₂O leachate may contain Li^{t} cation accompanied with CO₃²⁻, F⁻, AlO₂⁻, Si₄O₈(OH)₄₄⁻, and PO₄³⁻ anions.

### C3. Case Study of Li2CO3 Production

### C3.1. Conditions to Operate ELIS

Identifying the dissolved species suggests that size-exclusion-based filtrations like nanofiltration and reverse osmosis may not achieve the separation of Li^{t} and CO₃²⁻ from additional anions. Moreover, the conventional Li extraction from Li brine is a multistep process including the use of holding tanks, heating equipment, and chemicals for pH adjustment and solids settling. To resolve such an issue while simplifying the process, using the ELIS is proposed to solely purify Li^{t}. Because of the cation selectivity of the membrane, Li^{t} is the only species that can pass through the membrane from the anode to cathode.

51.442 g of the H₂O leachate as anolyte and 73.793 g of 0.12 M Li₂CO₃ as catholyte were continuously circulated in the ELIS at 15 mL min⁻¹ and at 0.5 A for 1 hour. Once the operation was completed, the catholyte was dried in a Thermo Scientific oven to recover Li salts for EDS and XRD analysis to validate the feasibility of ELIS for purifying Li.

### C3.2. Solids Characterization

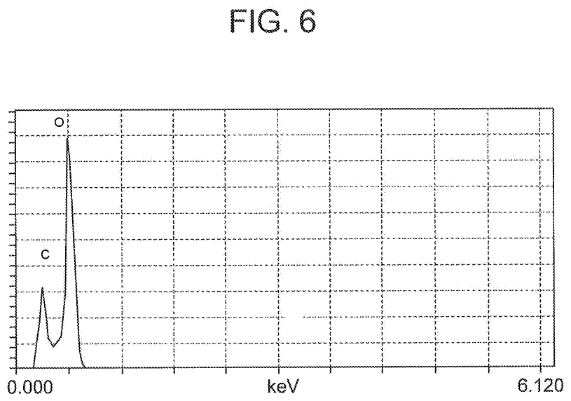

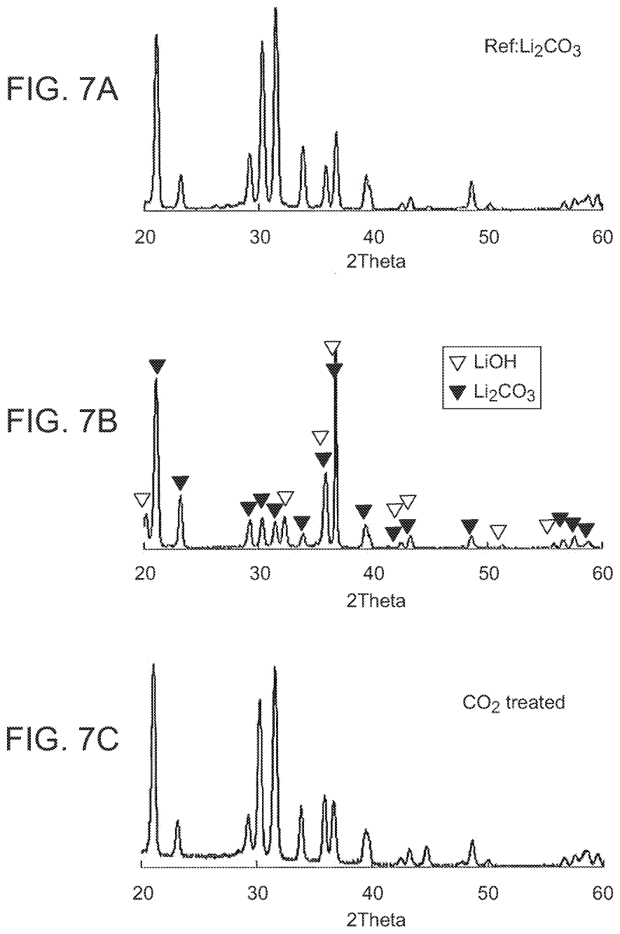

To validate our understanding, the solids after drying the catholyte were analyzed. The EDS spectrum of FIG. 6 shows no detection of F, Al, Si, and P in comparison to those in FIG. 5. Moreover, comparing the XRD pattern of FIGS. 7A and 7B, the mixed phases of Li₂CO₃ and LiOH are observed in the solids from drying the catholyte, where the Li₂CO₃ comes from the starting catholyte containing Li₂CO₃. To produce a high quality of Li₂CO₃ salt, the catholyte was purged using 14 vol % CO₂ until its pH was reduced to 8.2. Recovered solids were characterized using XRD. As shown in FIG. 7A versus 7C, very similar XRD patterns are observed, evidencing the formation of Li₂CO₃ only in the solids from the CO₂-treated catholyte.

### C4. Case Study of LiOH Production

### C4.1. Conditions to Operate ELIS

96.523 g of the H₂O leachate as anolyte and 94.465 g of 0.056 M LiOH as catholyte were continuously circulated at 15 mL min⁻¹ and 0.25 A for approximate 2 hours. Once the operation was completed, the resulting anolyte and catholyte were characterized to look at changes in the pH, conductivity, and alkalinity caused by the Li transport across the membrane in addition to characterizing the solids by EDS and XRD. (Please note that to prevent the formation of Li₂CO₃ via CO₂ reacting with LiOH, the drying process was performed under vacuum.)

### C4.2. Liquid and Solids Characterization

Decreased anolyte values and increased catholyte values in Table 2 mean that Li⁺ has been moved from the anolyte to catholyte loops of the ELIS during water electrolysis. Briefly, decreased anolyte pH is caused by consuming OH⁻ toward O₂ evolution via 4OH⁻—O₂+2H₂O+4e⁻; and on the other hand, increased catholyte pH is accounted for by H₂ evolution via 2H₂O+2e⁻—H₂+2OH⁻, subsequently leaving OH⁻ in the catholyte. Due to the charge neutrality of a solution and use of cation-selective membrane, Li⁺ is the only species that can be moved through the membrane to balance the OH⁻. As a result, high-quality of LiOH salt will be produced after H₂O is removed from the catholyte.

TABLE 2
Changes in conductivity, pH, and alkalinity of the anolyte and
catholyte before and after Li purification using the ELIS.

| | Sample | Conductivity/mS | pH | Alkalinity/M |
|---|---|---|---|---|
| Starting | Anolyte | 18.6 | 12.66 | 0.0949 |
| | Catholyte | 17.3 | 12.57 | 0.0556 |
| Ending | Anolyte | 2.46 | 7.37 | 0.0165 |
| | Catholyte | 25.3 | 12.8 | 0.1258 |

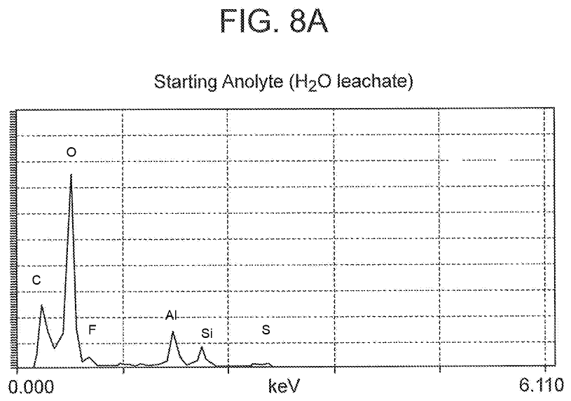

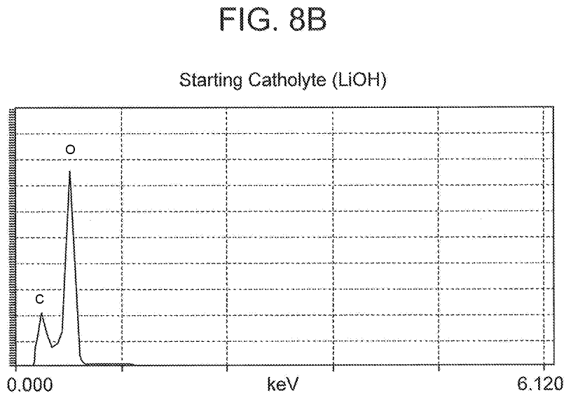

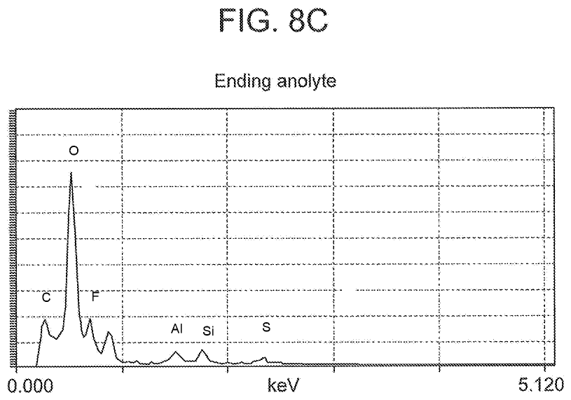

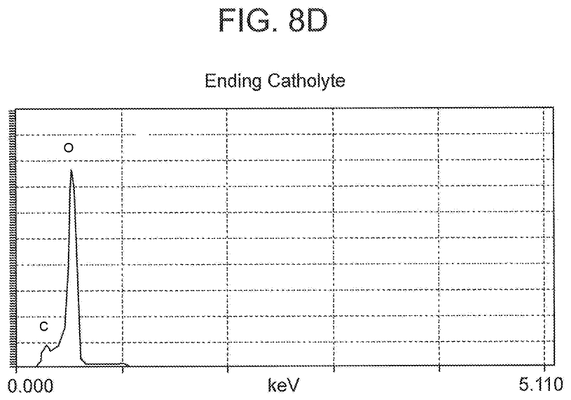

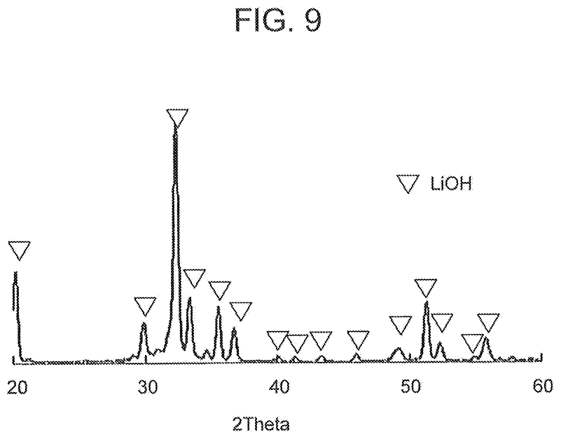

To examine the quality of LiOH salts, EDS and XRD analyses were carried out for the solids after removing H₂O from the catholyte. In comparison to FIG. 8A, the peaks representing Al, Si, and F vanish in FIG. 8D, suggesting that the anions of AlO₂⁻, Si₄O₈(OH)₄₄⁻, and PO₄³⁻ have been isolated in the anolyte loop by the cation exchange membrane. (Please note that the peak for carbon comes from the carbon tape that was used to hold the powder sample.) Furthermore, the peak assignments in the XRD pattern of FIG. 9 suggest the formation of high purity LiOH solids as per the peak assignments.

Each of the following terms written in singular grammatical form: “a”, “an”, and the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

It is to be fully understood that certain aspects, characteristics, and features, of the system and method, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the method which are illustratively described and presented in combination or sub-combination in the context or format of a single embodiment may also be illustratively described and presented in the context or format of a plurality of separate embodiments.

Although the system and method of recycling lithium ion batteries have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A method of recycling lithium-ion batteries, comprising:
roasting black mass from lithium-ion batteries to produce a reduced black mass;
conducting simultaneous aqueous leaching and wet magnetic separation of the reduced black mass for (a) extracting soluble lithium species and (b) enriching metallic Ni—Co; and
subjecting the extracted soluble lithium species to electrochemical lithium ion purification.

2. The method of claim 1, further including producing hydrogen gas during the electrochemical lithium ion purification.

3. The method of claim 2, further including using the hydrogen gas produced during the electrochemical lithium ion purification to perform the roasting of the black mass.

4. The method of claim 1, wherein the subjecting of the extracted soluble lithium species to electrochemical lithium ion purification includes (a) generating hydroxide ions and hydrogen gas at a cathode in a cathode compartment of a flow cell on a first side of an ion exchange membrane, (b) generating oxygen gas at an anode in an anode compartment of the flow cell, (c) allowing passage of lithium ions from the extracted soluble lithium species through the ion exchange membrane from the anode compartment to the cathode compartment to balance out the hydroxide ions generated at the cathode and (d) recovering purified lithium hydroxide from the flow cell.

5. The method of claim 4, further including using the hydrogen gas produced during the electrochemical lithium ion purification to perform the roasting of the black mass.

6. The method of claim 5, further including crushing lithium ion batteries to prepare the black mass for roasting.

7. The method of claim 6, further including applying a voltage of about 2.5-6.5 volts at a current density of about 20-1150 mA/cm² across the anode and the cathode during the electrochemical lithium ion purification.

8. The method of claim 7, further including contacting lithium hydroxide from the flow cell with carbon dioxide in a membrane contactor to produce lithium carbonate.

9. A system for recycling lithium ion batteries, comprising:
a roaster adapted for reductive roasting of a lithium ion battery black mass and producing a reduced black mass;
an aqueous leaching and wet magnetic separator, downstream from the roaster, adapted for (a) extracting soluble lithium species and (b) enriching metallic Ni—Co from the reduced black mass; and
an electrochemical lithium ion separator, downstream from the aqueous leaching and wet magnetic separator, adapted for purifying lithium hydroxide from the extracted lithium species.

10. The system of claim 9, further including a shredder adapted for shedding the lithium ion batteries and making the lithium ion battery black mass delivered to the roaster.

11. The system of claim 10, wherein the roaster is a rotary reactor.

12. The system of claim 11, wherein the electrochemical purifier includes a flow cell having an anode compartment, a cathode compartment, an ion exchange membrane separating the anode compartment from the cathode compartment, an anode in the anode compartment and a cathode in the cathode compartment.

13. The system of claim 12, further including a voltage source adapted to supply a voltage potential across the anode and the cathode.

14. The system of claim 13, wherein the voltage source is adapted to supply a voltage of about 2.5-6.5 volts at a current density of about 20-1150 mA/cm² across the anode and the cathode during the electrochemical lithium ion purification.

15. The system of claim 14, wherein the anode is a dimensionally stable anode.

16. The system of claim 14, wherein the anode is made from titanium.

17. The system of claim 16, wherein the cathode is made from a material selected from a group consisting of graphite, iron, nickel, iron-nickel alloy, nickel chromium alloy or combinations thereof.

18. The system of claim 14, wherein the electrochemical lithium ion separator further includes a membrane contactor adapted for contacting the purified lithium hydroxide received from the flow cell with carbon dioxide and converting the purified lithium hydroxide to lithium carbonate.

19. The system of claim 12, wherein the electrochemical lithium ion separator further includes a membrane contactor adapted for contacting the purified lithium hydroxide received from the flow cell with carbon dioxide and converting the purified lithium hydroxide to lithium carbonate.

20. The system of claim 9, wherein the electrochemical lithium ion separator further includes a flow cell and a membrane contactor adapted for contacting the purified lithium hydroxide received from the flow cell with carbon dioxide and converting the purified lithium hydroxide to lithium carbonate.
